(19) United States
(12) Patent Application Publication
(10) Pub. No.: US 2006/0174621 A1
(43) Pub. Date: Aug. 10, 2006

(54) Two-turbocharger engine and method

(76) Inventors: Kai Chen, Villa Park, IL (US); Adam C. Lack, Willow Springs, IL (US)

Correspondence Address: INTERNATIONAL ENGINE INTELLECTUAL PROPERTY COMPANY, 4201 WINFIELD ROAD, P.O. BOX 1488, WARRENVILLE, IL, 60555, US

(21) Appl. No.: 11/051,398

(22) Filed: Feb. 4, 2005

(51) Int. Cl. F02B 33/44

(52) U.S. Cl. 60/612

(57) ABSTRACT

An internal combustion engine having (200) a first turbocharger (209) in fluid communication with a first exhaust manifold (207) and fluidly communicating with an intake manifold (205), a first exhaust gas control valve (223) in fluid communication with a second exhaust manifold (207), a second turbocharger (215) in fluid communication with the first gas control valve (223) and the intake manifold (205), a crossover passage (222) in fluid communication with the first exhaust manifold (207) and the second exhaust manifold (207), and a first air control valve (225), in fluid communication with the second turbocharger (215) and fluidly connected with the intake manifold (205).

### FIELD OF THE INVENTION

This invention relates to the operation of turbocharged internal combustion engines, including but not limited to engines having at least two turbochargers.

### BACKGROUND OF THE INVENTION

Internal combustion engines typically use turbochargers to increase pressure in their intake manifolds and increase their power. An internal combustion engine having a single turbocharger is typically tuned for a specific power and torque output. Some engines have more than one turbocharger because a second turbocharger helps tune the engine for optimal performance over a wider range of engine speeds and loads.

Most engines having two turbochargers are configured in either a twin configuration, where the turbochargers are connected in parallel, or a staged configuration, where the turbochargers are in series, i.e., the outlet of one turbine is connected to the inlet of another turbine.

Modern engines may have either a twin or a staged configuration. Each configuration has its advantages and disadvantages. One advantage of a twin configuration is the smaller size of each of the turbines as compared to the turbine of a single turbocharged engine (because each of the twin turbines is expected to flow nearly half of the engine's exhaust gas). The smaller size of the turbines is beneficial to the off-the-line performance of the engine because the smaller a turbine is, the faster its turbine wheel can increase rotational speed, and thus the faster air pressure in the intake manifold of the engine increases. One disadvantage of the twin configuration, however, is the capability of the engine to generate enough intake manifold pressure for performance, generate adequate pressure difference between its exhaust manifold and its intake manifold to drive adequate amounts of Exhaust Gas Recirculation (EGR), and still maintain acceptable transient performance.

Accordingly, there is a need for improved EGR capability and improved air supply in engines having twin turbochargers.

### SUMMARY OF THE INVENTION

An internal combustion engine includes two turbochargers and two exhaust manifolds. A first turbocharger is in fluid communication with a first exhaust manifold and fluidly communicating with an intake manifold. A first exhaust gas control valve is in fluid communication with a second exhaust manifold. A second turbocharger is in fluid communication with the first exhaust gas control valve and the intake manifold. A crossover passage is in fluid communication with the first exhaust manifold and the second exhaust manifold. A first air control valve is in fluid communication with the second turbocharger and the intake manifold.

A method for use with an internal combustion engine comprises the steps of directing exhaust gas from a first exhaust manifold into a first turbine and preventing at least some exhaust gas from a second exhaust manifold from entering a second turbine. At least some exhaust gas from the second exhaust manifold is selectively mixed with exhaust gas from the first exhaust manifold. Air at a high pressure is inhibited from mixing with intake air at a low pressure.

### BRIEF DESCRIPTION OF THE DRAWINGS

FIG. 1 is a prior art block diagram of an engine having two turbochargers.

FIG. 2 is a block diagram of an engine having two turbochargers in accordance with the invention.

FIG. 3 and FIG. 4 are flowcharts for use with an internal combustion engine in accordance with the invention.

FIG. 5 is a graphical representation of air-to-fuel ratio versus engine speed in accordance with the invention.

FIG. 6 is a graphical representation of intake manifold pressure versus engine speed in accordance with the invention.

FIG. 7 is a graphical representation of exhaust manifold pressure minus intake manifold pressure versus engine speed in accordance with the invention.

FIG. 8 is a graphical representation of EGR rate versus engine speed in accordance with the invention.

### DESCRIPTION OF PREFERRED EMBODIMENT

The following describes an apparatus for and method of operating an internal combustion engine having two turbochargers in parallel configuration for optimal EGR rate and transient performance. The performance of the engine is improved by selectively enabling one of the two turbochargers according to the operation mode of the engine.

The internal combustion engine is capable of switching between at least two modes of operation, one for low engine speeds and loads, and one for higher engine speeds and loads. The engine is capable of switching between operating modes a plurality of times during a normal cycle of operation.

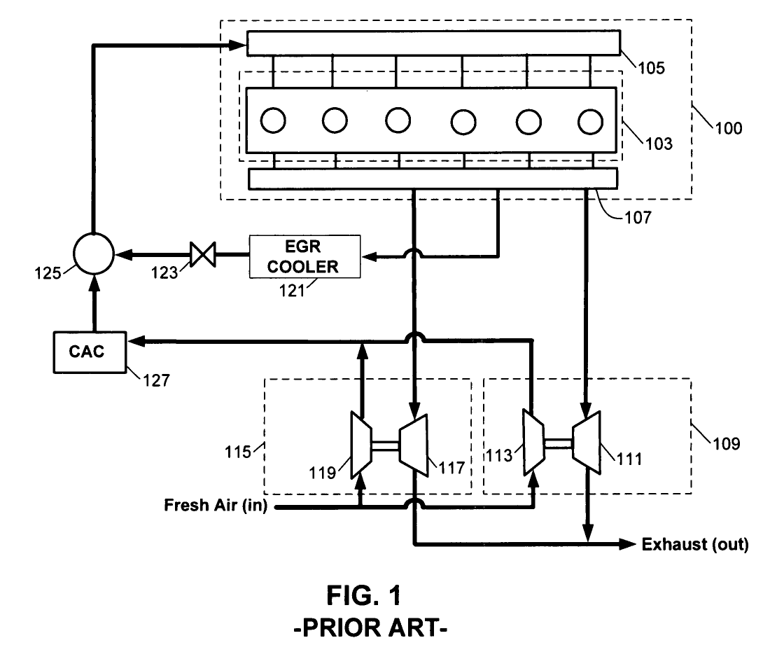

A typical configuration in the art for an internal combustion engine having two turbochargers is shown in FIG. 1. The engine 100 includes a crankcase 103 having a plurality of combustion cylinders. Air is provided to the cylinders via an intake manifold 105. Fuel is mixed with the air in each cylinder forming a mixture. The mixture is compressed and ignites giving power to pistons (not shown) that are disposed within the cylinders. The motion of each piston is transferred through a crankshaft (not shown) to a vehicle or other system that uses the engine 100 as a power source.

One product of the combustion of the fuel and air mixture in the cylinders is exhaust gas. Exhaust gas is expelled from each cylinder after combustion and is typically collected in an exhaust manifold 107. The exhaust gas entering the exhaust manifold 107 is at a state of high pressure and temperature. This high-energy state of the exhaust gas is used to run turbochargers that improve the performance of the engine 100. Turbines typically convert a portion of exhaust energy into work that is used in a compressor, which pumps intake air into the engine.

The engine 100 is shown with a first turbocharger 109 having a first turbine 111 in fluid communication with the exhaust manifold 107 and a first compressor 113 in fluid communication with the intake manifold 105. A second turbocharger 115 has a second turbine 117 that is connected to the exhaust manifold 107 in a parallel configuration with the first turbine 111, and a second compressor 119 that is connected to the intake manifold 105, in parallel with the first compressor 113. During operation of the typical engine 100, the first turbine 111, and second turbine 117 receive substantially equal amounts of exhaust gas from the exhaust manifold 107. Similarly, the first compressor 113 and second compressor 119 pump substantially equal amounts of air into the intake manifold 105.

For emission control purposes, many modern engines also have an EGR system. The EGR system typically includes an EGR cooler 121 connected in series with an EGR valve 123. Exhaust gas going through the EGR cooler 121 and the EGR valve 123 is typically mixed with intake air at a mixing junction 125 before entering the intake manifold 105. A Charge Air Cooler (CAC) 127 is also shown in FIG. 1. Compressed intake air is cooled in the CAC 127 before entering the intake manifold 105.

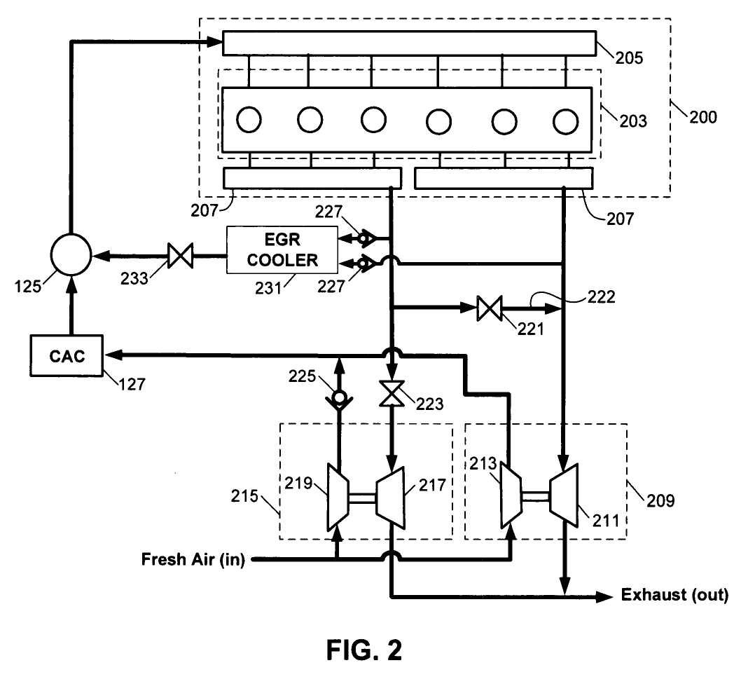

An engine 200 having two turbochargers with additional flow control is shown in FIG. 2. The engine 200 includes a crankcase 203 having a plurality of combustion cylinders. Air is provided to the cylinders via an intake manifold 205 and expelled into a first exhaust manifold 207 and a second exhaust manifold 207.

The engine 200 has a first turbocharger 209 with a first turbine 211 in fluid communication with the first exhaust manifold 207 and a first compressor 213 in fluid communication with the intake manifold 205 through the CAC 127. A second turbocharger 215 has a second turbine 217 connected to the second exhaust manifold 207 in parallel with the first turbine 211 and a second compressor 219 connected to the intake manifold 205 in parallel with the first compressor 213 through an intake air control valve 225 and the CAC 127. The turbines 211 and 217 are shown as fixed geometry turbines, but may advantageously be variable geometry turbines. A first exhaust gas control valve 221 is optional and is advantageously connected between the first exhaust manifold 207 and the second exhaust manifold 207, upstream of the turbines 111, 117. A crossover passage 222 that fluidly connects the first exhaust manifold 207 with the second exhaust manifold 207 transfers exhaust gas from the second exhaust manifold 207 to the first exhaust manifold 207.

A second exhaust gas control valve 223 is disposed between the second turbine 217 and the second exhaust manifold 207 at a location downstream of the crossover passage 222 and upstream of the second turbine 217. An intake air control valve 225 is disposed downstream of the second compressor 219. The intake air control valve 225 is advantageously a check valve as shown, but may alternatively be any other type of actuated or non-actuated flow control device. A first EGR check valve 227 and a second EGR check valve 227 are optional and are shown disposed at a gas inlet side of an EGR cooler 231. An EGR valve 233 is connected in series with the EGR cooler 231. Although the first exhaust manifold 207 and the second exhaust manifold 207 are shown as being similar, they may alternatively have different features and characteristics.

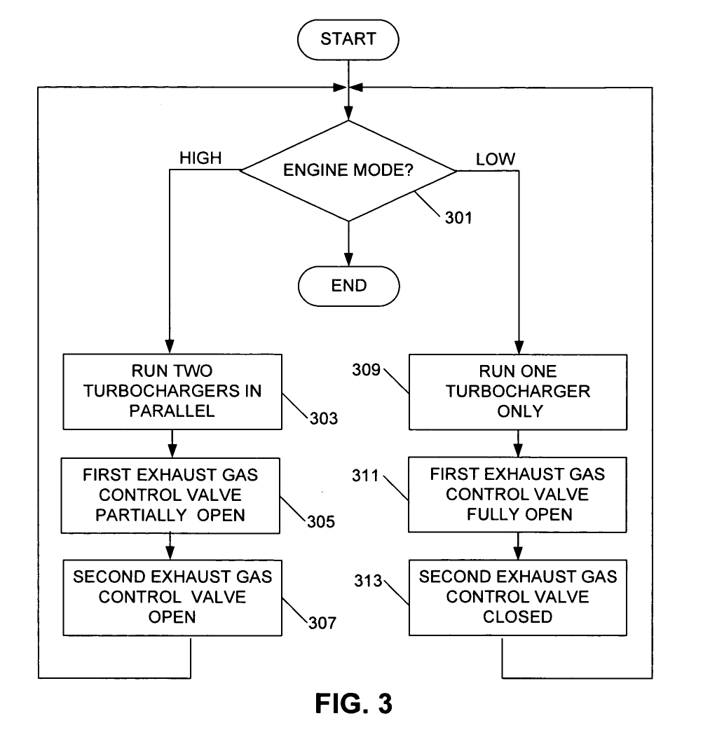

During operation of the engine 200, a change is made to the position of the first exhaust gas control valve 221 and the second exhaust gas control valve 223 according to an engine-operating mode of the engine 200. During higher engine speeds and loads, the engine 200 operates in a high mode, and during lower engine speeds and loads, the engine 200 operates in a low mode. The position of each of the exhaust gas control valves 221 and 223 during each engine-operating mode is shown in the flowchart of FIG. 3.

At step 301, the engine-operating mode is determined. An engine electronic control module (ECM) (not shown) advantageously performs this determination, although other device(s) may be utilized. The determination compares the load and engine speed of the engine to given thresholds and outputs either low mode or high mode as the engine-operating mode. Low mode is output when the engine is operating at low engine speed and low engine load. Conversely, if the engine speed and engine load are high, the engine mode is high mode.

If the engine is operating in a high mode at step 301, the process continues with step 303 where both turbochargers 209 and 215 are run in a parallel fashion, the first exhaust valve 221 is opened at step 305, the second exhaust gas control valve 223 is substantially opened at step 307 at a position of, for example, more than 70% open, and the process continues with step 301. If the turbines 211 and 217 are fixed geometry turbines, the efficiency of the engine may be increased in high mode by preservation of exhaust system pulsations, which may be accomplished by closing the first exhaust gas control valve 221 at step 305, thus preventing substantial exhaust gas exchange between the exhaust manifolds 207.

If at step 301 the engine is running in low mode, only the first turbine 211 is operated at step 309, the first exhaust control valve 221 is fully opened at step 311, and the second exhaust gas control valve 223 is substantially fully closed, for example 95% or more closed, in step 313, and the process continues with step 301. The second exhaust gas control valve 223 may not be closed completely to allow some exhaust gas to enter the second turbine 217, allowing it to nominally operate. The low mode valve configuration prevents a majority, or more than 51% of the available amount, of exhaust gas from entering the second turbine 217, and routes the majority of exhaust gas from the second exhaust manifold 207 to pass through the crossover passage 222, primarily, and mix with exhaust gas from the first exhaust manifold 207 before entering the first turbine 211. If an EGR cooler 231 is installed with the engine, an additional passage may be provided for the transfer of exhaust gas from the second exhaust manifold 207 to the first exhaust manifold 207 through the connections for the EGR cooler 231, unless the check valves 227 are installed. If at step 301 the engine is no longer running, the process ends.

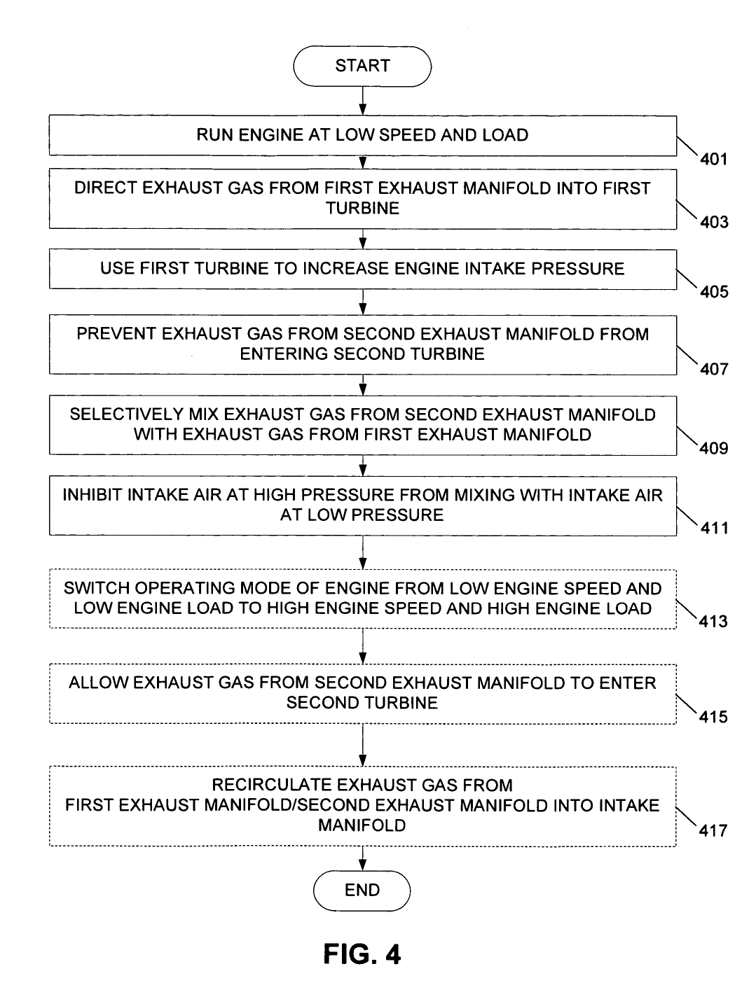

A method of operation is shown in FIG. 4. At step 401, the engine 200 is run at a low speed and load. At step 403, exhaust gas is directed from a first exhaust manifold 207 into a first turbine 211. At step 405, the first turbine 211 or turbocharger 209 is used to increase intake pressure of the engine 200. At step 407, at least some exhaust gas is prevented from entering a second turbine 217 from a second exhaust manifold 207, essentially disengaging the second turbine 217 or turbocharger 215. At step 409, at least some exhaust gas from the second exhaust manifold 207 is selectively mixed with exhaust gas from the first exhaust manifold 207. At step 411, intake air at a high pressure is inhibited from mixing with intake air at a low pressure. At an optional step 413, an operating mode of the engine 200 may be switched from a low engine speed and low engine load to a high engine speed and a high engine load. At optional step 415, some exhaust gas from the second exhaust manifold 207 is allowed to enter a second turbine 217, essentially reengaging the second turbine 217 or turbocharger 215. At optional step 417 exhaust gas from at least one of the first exhaust manifold 207 and the second exhaust manifold 207 is recirculated into an intake manifold 205, and the process ends.

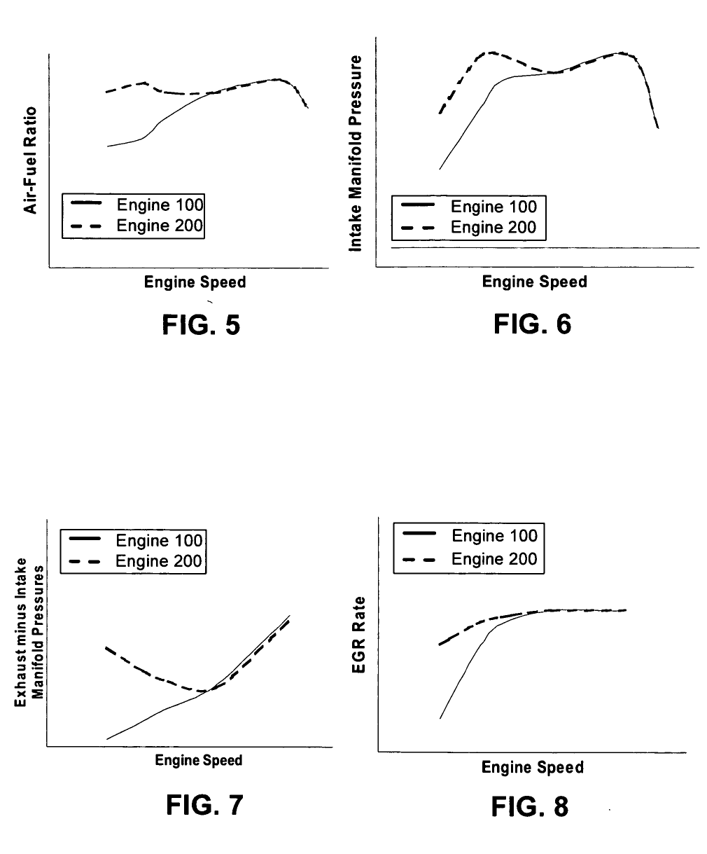

Some of the advantages of the present invention for engines operating in low engine speeds and loads are shown in the example performance curves of the graphs of FIG. 5 through FIG. 8. Curves illustrating examples of an unimproved engine 100 are shown with a solid line, and curves illustrating examples of an improved engine 200 are shown with a dashed line. By using one turbocharger in low operating mode, more air enters the engine. An engine's air-to-fuel ratio is a ratio of the amount of air pushed into the engine divided by the amount of fuel delivered into the engine during operation. Relatively high air-to-fuel ratios typically result in an adequate amount of air available to combust with the fuel, and yield complete combustion. Complete combustion gives the engine desirable attributes that include more engine power and torque, smoother engine operation, and lower emissions.

At low engine speeds, the amount of exhaust gases expelled by an engine is relatively low. An engine 100 with two turbochargers running simultaneously is not able to operate both turbochargers efficiently enough to push an adequate amount of air into the engine. The engine 100 might experience low air-to-fuel ratios at low engine speeds, as shown in FIG. 5 that graphically depicts air-to-fuel ratio on the vertical axis versus engine speed on the horizontal axis. An engine 200 disengages one of the turbochargers and effectively uses all of its exhaust gas to run the single operating turbocharger. With twice as much exhaust gas going through the single operating turbine of the engine 200, as compared to the two turbines on the unimproved engine 100, the improved engine 200 advantageously experiences higher air-to-fuel ratios in comparison to the unimproved engine 100. About half way through the engine speed operating range, the engine 200 switches into the high mode that runs both turbochargers, and matches the performance of the unimproved engine 100.

In addition, the intake manifold pressure of an improved engine 200 is advantageously higher than that of an unimproved engine 100 at a low mode, as shown in FIG. 6. The intake manifold pressure of the improved engine 200 running a single turbocharger is compared to the intake manifold pressure of the unimproved engine 100 running both of its turbochargers. As before, after the engine 200 switches to high mode, the performance essentially converges. The higher intake manifold pressure at the low mode advantageously gives the engine 200 improved launch performance.

Another advantage of this invention is realized in engines having an EGR system. The pressure driving EGR gas to flow from the exhaust to the intake of the engine is the difference in pressure between the exhaust and the intake. This difference in pressure for the engine 200 is compared to that of the engine 100 in FIG. 7. A quantity equal to the exhaust pressure minus the intake pressure (what is referred to in the art as the EGR driving pressure) is higher when the improved engine 200 is in low mode than that for the unimproved engine 100. When the engine 200 switches to high mode, the performance of the two engines 100 and 200 is similar. In general, exhaust pressure is positively correlated to turbine efficiency, and negatively correlated to exhaust flow area. The information shown in FIG. 7 is attributed to the difference of exhaust flow area between the improved engine 200 and the unimproved engine 100, each running in a low mode. The engine 100 using both turbochargers has twice as much flow area to expel exhaust gas to the atmosphere as compared to the engine 200 running a single turbocharger, while in low-mode operation.

A result of the higher EGR driving force in low mode for the engine 200 is the ability to advantageously run higher EGR rates. A comparison of EGR rates between the engines 100 and 200 is shown in FIG. 8. The performance of the improved engine 200 converges with the performance of the engine 100 as engine speed increases. At low engine speeds, the engine 200 is advantageously capable of running higher rates of EGR.

The embodiment of the present invention described above is illustrated using an engine with six cylinders arranged linearly. This invention is well-suited for and may be embodied in different engine configurations, for instance engines having their cylinders in a “V” configuration or engines having more or fewer than six cylinders.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. An internal combustion engine comprising:
a first turbocharger in fluid communication with a first exhaust manifold and fluidly communicating with an intake manifold;
a first exhaust gas control valve in fluid communication with a second exhaust manifold;
a second turbocharger in fluid communication with the first exhaust gas control valve and the intake manifold;
a crossover passage in fluid communication with the first exhaust manifold and the second exhaust manifold;
a first air control valve, in fluid communication with the second turbocharger and the intake manifold.

2. The internal combustion engine of claim 1, further comprising an EGR valve in fluid communication with the intake manifold.

3. The internal combustion engine of claim 2, further comprising an EGR cooler in fluid communication with the EGR valve.

4. The internal combustion engine of claim 3, wherein an EGR cooler and the EGR valve are in fluid communication with the first exhaust manifold and the second exhaust manifold.

5. The internal combustion engine of claim 4, further comprising a first check valve and a second check valve, wherein the first check valve and the second check valve are disposed at a gas inlet side of the EGR cooler.

6. The internal combustion engine of claim 1, wherein the first air control valve is an air control check valve.

7. The internal combustion engine of claim 1, wherein the first turbocharger comprises a first turbine in fluid communication with the first exhaust manifold and a first compressor fluidly communicating with the intake manifold, and wherein the second turbocharger comprises a second turbine in fluid communication with the second exhaust manifold and a second compressor fluidly communicating with the intake manifold.

8. The internal combustion engine of claim 1, further comprising a second gas control valve disposed in the crossover passage.

9. A method comprising the steps of:
directing exhaust gas from a first exhaust manifold into a first turbine;
preventing at least some exhaust gas from a second exhaust manifold from entering a second turbine;
selectively mixing at least some exhaust gas from the second exhaust manifold with exhaust gas from the first exhaust manifold;
inhibiting intake air at a high pressure from mixing with intake air at a low pressure.

10. The method of claim 9, further comprising the step of circulating exhaust gas from at least one of the first exhaust manifold and the second exhaust manifold to an intake manifold.

11. The method of claim 10, further comprising the step of inhibiting intake air from entering the first exhaust manifold and the second exhaust manifold.

12. The method of claim 9, further comprising the step of determining an engine-operating mode.

13. The method of claim 9, wherein the preventing step is preventing all of the exhaust gas from the second exhaust manifold from entering the second turbine.

14. A method for an internal combustion engine comprising the steps of:
running the internal combustion engine at a low engine speed and a low engine load;
using a first turbocharger with exhaust gas from a first exhaust manifold to increase an engine intake pressure;
disengaging a second turbocharger from exhaust gas coming from a second exhaust manifold;
preventing intake air at a high pressure from mixing with intake air at a low pressure;
switching an operating mode of the internal combustion engine from the low engine speed and the low engine load to a high engine speed and a high engine load;
reengaging a second turbocharger with exhaust gas coming from the second exhaust manifold;
recirculating exhaust gas from at least one of the first exhaust manifold and the second exhaust manifold into an intake manifold.

15. The method of claim 14, further comprising the step of selectively routing exhaust gas from the second exhaust manifold into the first exhaust manifold.

16. The method of claim 14, further comprising the step of cooling compressed intake air.

17. The method claim 14, further comprising the steps of recirculating exhaust gas and cooling recirculated exhaust gas.

18. The method of claim 14, further comprising the step of determining an engine-operating mode.

19. The method of claim 14, further comprising the step of switching-back the operating mode of the internal combustion engine from a high engine speed and a high engine load to the low engine speed and the low engine load.

20. The method of claim 19, further comprising the step of repeating at least one of the switching step and the switching-back step.
